(19) United States
(12) Patent Application Publication
(10) Pub. No.: US 2010/0295497 A1
(43) Pub. Date: Nov. 25, 2010

(54) MOTOR CONTROL DEVICE AND MOTOR CONTROL SYSTEM

(75) Inventor: Shoji TAKAMATSU, Fukuoka (JP)

Correspondence Address: Ditthavong Mori & Steiner, P.C., 918 Prince Street, Alexandria, VA, 22314, US

(73) Assignee: KABUSHIKI KAISHA YASKAWA DENKI, Kitakyushu-shi (JP)

(21) Appl. No.: 12/786,355

(22) Filed: May 24, 2010

(30) Foreign Application Priority Data
May 25, 2009 (JP) 2009-125562
Nov. 18, 2009 (JP) 2009-262745

(51) Int. Cl. G05B 11/36

(52) U.S. Cl. 318/671

(57) ABSTRACT

A motor control device includes a position command filter. The position command filter is configured to filter a position command in accordance with a predetermined filter constant. A controller is configured to output a torque command to control a motor based on the filtered position command and based on a detected position of the motor such that the position of the motor follows the filtered position command. A power converter is configured to apply a voltage command based on the torque command to a motor winding in the motor. A shift amount calculator is configured to calculate a shift amount of the motor per sampling time based on the position command. A filter constant setting part is configured to set the filter constant of the position command filter based on the shift amount.

### CROSS-REFERENCE TO RELATED APPLICATIONS

The present application claims priority under 35 U.S.C. §119 to Japanese Patent Application No. 2009-125562 filed May 25, 2009, and Japanese Patent Application No. 2009-262745 filed Nov. 18, 2009. The contents of these applications are incorporated herein by reference in their entirety.

### BACKGROUND OF THE INVENTION

1. Field of the Invention

The present invention relates to a motor control device and a motor control system.

2. Discussion of the Background

Servomotors are used to drive mechanism systems such as semiconductor manufacturing apparatuses, robots, and various other machine tools. Properties of a servomotor, such as a positioning property, are influenced by characteristics of a target mechanism system (e.g., resonant frequency and antiresonant frequency). In an attempt to reduce the influence of the characteristics of the target mechanism, Japanese Patent Application Publication No. 2005-168225 discloses removing oscillation components of a position command through vibration suppression filters provided against the position command. Specifically, two vibration suppression filters are used to remove mutually different oscillation components, and either one of the filters is selected according to a moving direction, to save the settling time. Japanese Patent Application Publication (KOKAI) No. 7-123762 discloses, in an attempt to improve followability of motor speed, generating a feed forward signal while switching between two filters of mutually different delay times according to a shift amount.

### SUMMARY OF THE INVENTION

According to one aspect of the present invention, a motor control device includes a position command filter, a controller, a power converter, a shift amount calculator, and a filter constant setting part. The position command filter is configured to filter a position command in accordance with a predetermined filter constant. The position command is a step signal. The controller is configured to output a torque command to control a motor based on the position command filtered by the position command filter and based on a position of the motor detected by a position detection device such that the position of the motor follows the position command filtered by the position command filter. The power converter is configured to apply a voltage command based on the torque command to a motor winding in the motor. The shift amount calculator is configured to calculate a shift amount of the motor per sampling time based on the position command. The filter constant setting part is configured to set the filter constant of the position command filter based on the shift amount calculated by the shift amount calculator.

According to another aspect of the present invention, a motor control system includes a motor, a command output device, a position detection device, a motor control device, a position command filter, a controller, a power converter, a shift amount calculator, and a filter constant setting part. The motor is configured to drive a load. The command output device is configured to output a position command indicating a position of the motor. The position command is a step signal. The position detection device is configured to detect the position of the motor. The motor control device is configured to drive the motor based on the position command. The motor control device includes a position command filter, a controller, a power converter, a shift amount calculator, and a filter constant setting part. The position command filter is configured to filter the position command in accordance with a predetermined filter constant. The controller is configured to output a torque command to control the motor based on the position command filtered by the position command filter and the position of the motor detected by the position detection device such that the position of the motor follows the position command filtered by the position command filter. The power converter is configured to apply a voltage command based on the torque command to a motor winding in the motor. The shift amount calculator is configured to calculate a shift amount of the motor per sampling time based on the position command. The filter constant setting part is configured to set the filter constant of the position command filter based on the shift amount calculated by the shift amount calculator.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an explanatory diagram for explaining a configuration of a motor control system according to a first embodiment of the present invention;

FIG. 2 is an explanatory diagram for explaining a configuration and operations of a position command filter in the first embodiment of the present invention;

FIG. 3A is an explanatory diagram for explaining a result of simulation in a positioning operation in a case where a shift amount is 1000 pulses in the first embodiment of the present invention;

FIG. 3B is an explanatory diagram for explaining a result of simulation in the positioning operation in the case where the shift amount is 1000 pulses in the first embodiment of the present invention;

FIG. 3C is an explanatory diagram for explaining a result of simulation in the positioning operation in the case where the shift amount is 1000 pulses in the first embodiment of the present invention;

FIG. 3D is an explanatory diagram for explaining a result of simulation in the positioning operation in the case where the shift amount is 1000 pulses in the first embodiment of the present invention;

FIG. 4A is an explanatory diagram for explaining a result of simulation in a positioning operation in a case where a shift amount is 10000 pulses in the first embodiment of the present invention;

FIG. 4B is an explanatory diagram for explaining a result of simulation in the positioning operation in the case where the shift amount is 10000 pulses in the first embodiment of the present invention;

FIG. 4C is an explanatory diagram for explaining a result of simulation in the positioning operation in the case where the shift amount is 10000 pulses in the first embodiment of the present invention;

FIG. 4D is an explanatory diagram for explaining a result of simulation in the positioning operation in the case where the shift amount is 10000 pulses in the first embodiment of the present invention;

FIG. 5 is an explanatory diagram for explaining a relation between a shift amount and a filter constant in a position command filter in the first embodiment of the present invention;

FIG. 6 is an explanatory diagram for explaining a configuration of a motor control system according to a second embodiment of the present invention;

FIG. 7 is an explanatory diagram for explaining a relation between a shift amount and each of a filter constant and a control constant in the second embodiment of the present invention; and

FIG. 8 is an explanatory diagram for explaining a configuration of a motor control system of related art.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Note that various functions and means may be incorporated in an actual motor control device. For convenience of description, however, only the functions and means relating to the preferred embodiments of the present invention will be described in this specification and shown in the appended drawings.

### 1. Related Motor Control System

Prior to the description about the preferred embodiments of the present invention, with reference to FIG. 8, description will be given of a motor control system of related art. FIG. 8 is an explanatory diagram for explaining a configuration of the motor control system of related art.

As shown in FIG. 8, the motor control system includes a motor control device 1a, a command output device 2a, a motor 3, an encoder 4 that detects a position of the motor 3, and a two-inertia system load 5.

The motor control device 1a drives the motor 3, based on a position command from the command output device 2a, receives a feedback signal indicating the position of the motor 3 detected by the encoder 4, and controls the motor 3 such that the position command matches the feedback signal.

The two-inertia system load 5 is a robot arm, for example, and has frequency characteristic peak points a at a resonant point and an antiresonant point. Therefore, vibration is induced at the load 5 due to an antiresonant frequency peak in the motor 3.

Next, detailed description will be given of the motor control device 1a.

The motor control device 1a includes a controller 9a, a power converter 10, a vibration suppression filter 11, a filter switch part 12 and a command direction detection part 13.

Typically, the controller 9a performs position control and speed control. In many instances, the position control is P control (proportional control) and the speed control is PI control (proportional-plus-integral control). In the position control, the controller 9a multiplies, by a position proportional gain, a difference between the position command from the command output device 2a and the feedback signal indicating the position of the motor 3 from the encoder 4 to output it as a speed command. In the speed control, the controller 9a performs the PI control such that the speed command obtained in the position control becomes equal to a speed of the motor 3 which can be detected based on the feedback signal from the encoder 4, and outputs a torque command.

The power converter 10 includes an IGBT (Insulated Gate Bipolar Transistor), a MOSFET (Metal-Oxide-Semiconductor Field-Effect Transistor) and the like. The power converter 10 applies a voltage to a motor winding in the motor 3, based on the torque command output from the controller 9a.

The vibration suppression filter 11 has such a frequency characteristic that a gain decreases in a predetermined frequency band, as in a notch filter. Moreover, the vibration suppression filter 11 includes a first vibration suppression filter 11a and a second vibration suppression filter 11b which can be set selectively. The position command from the command output device 2a passes through the first vibration suppression filter 11a or the second vibration suppression filter 11b, and the first position command or the second position command thus obtained is output from the vibration suppression filter 11.

The command direction detection part 13 detects which one of a counterclockwise direction (hereinafter, referred to as a CCW direction) and a clockwise direction (hereinafter, referred to as a CW direction) is indicated by the position command from the command output device 2a, and outputs a command direction.

Herein, the filter switch part 12 selects the position command in accordance with the command direction. In the case where the command direction is the CCW direction, for example, the filter switch part 12 selects the first position command. In the case where the command direction is the CW direction, on the other hand, the filter switch part 12 selects the second position command. The filter switch part 12 gives the position command thus selected to the controller 9a. When the position command passes through the vibration suppression filter 11, a frequency component set at the first vibration suppression filter 11a or a frequency component set at the second vibration suppression filter 11b is removed therefrom. Therefore, the motor control device 1a can reduce vibration by matching the antiresonant frequency of the two-inertia system load 5 with the frequency set for the vibration suppression filter 11.

With the configuration described above, the motor control device 1a can automatically deal with changes in antiresonant frequency of FA (Factory Automation) system equipment. Herein, consideration is given to a robot for transporting an object. In many instances, motion of the robot is determined in advance. For example, the robot moves in the CCW direction when the object is mounted thereon and moves in the CW direction when no object is mounted thereon. Therefore, the motor control device of related art automatically selects the vibration suppression filter in accordance with the command direction to reduce vibration.

Meanwhile, a motor control device such as a control device for a galvano-scanner typically employs a step-like position command. In such a circumstance, it is desirable to realize the quick and precise positioning operation described above.

In a case where a command output device outputs a step-like position command, however, a whole position command corresponding to a shift amount is incorporated in a position deviation at once. Therefore, a torque command value to be output from a controller occasionally becomes large. Particularly, if the shift amount increases in a case where an inertial moment of a load is large, the torque command value sometimes exceeds an output limit value of a motor or an amplifier. If the torque command exceeds the output limit and therefore is limited, an overshoot occurs at a positioning characteristic. This disadvantage results in degradation of positioning accuracy.

According to the motor control system of related art, in order to solve this problem, a filter having such a time constant as to prevent a torque command value from exceeding an output limit value even in a case of a maximum shift amount is provided on a position command transmission path. However, if the shift amount is relatively small, the time constant of the filter to be required may not be large so much. Consequently, use of a time constant to be employed in a case where the shift amount is relatively large results in sacrifice of enhanced speed in a case where the shift amount is relatively small.

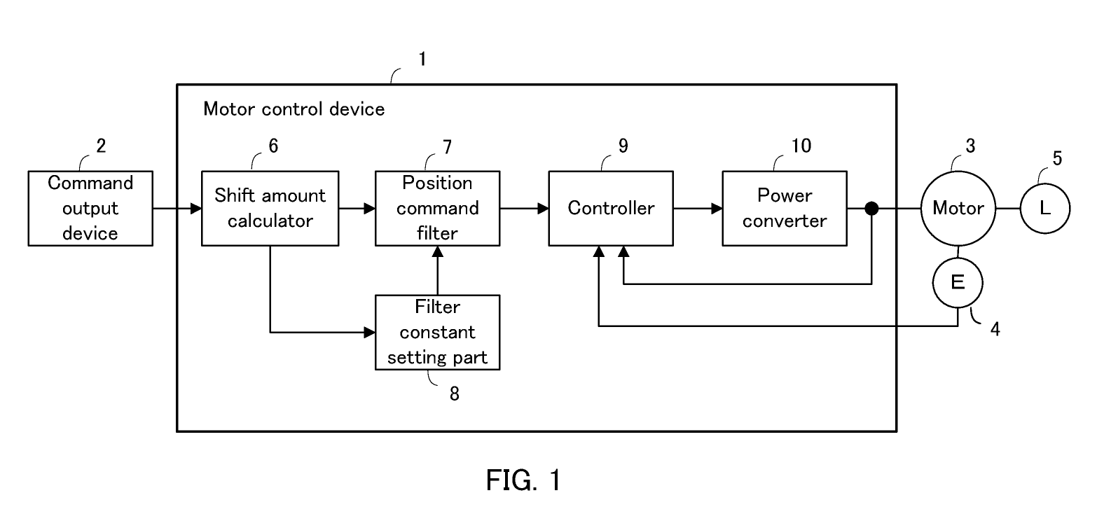

As a method for changing a characteristic of a filter for a position command, on the other hand, JP 07-123762 A discloses a method for changing a delay amount of a filter, based on a shift amount, to generate a feed forward signal, in order to improve followability (refer to pages 5 to 7 and see FIG. 1).

However, the technique disclosed in JP 07-123762 A is incapable of producing an effect of smoothing a position command only by delay of the position command even when a delay amount is changed at maximum. Consequently, this technique does not serve as means for preventing a torque command from exceeding an output limit value. In actual fact, even the technique disclosed in JP 07-123762 A causes a case where a torque command is limited, and has difficulty in improving positioning accuracy.

A motor control device and a motor control system according to the preferred embodiments of the present invention which has been completed by the present inventors each produce the following effects. That is, in a case where a command output device outputs a step-like position command, it is possible to perform a positioning operation with improved accuracy because a torque command does not exceed an output limit value even when a shift amount varies depending on applications. Further, it is possible to perform a quick positioning operation even in a case where the shift amount is relatively small.

With the motor control device and the motor control system according to the preferred embodiments of the present invention, it is possible to set a filter constant of a position command filter in accordance with a shift amount in a case where the command output device outputs a step-like position command. Accordingly, it is possible to use an appropriate position command filter in accordance with a shift amount. For example, in a case where an inertial moment of a load is relatively large, even if a shift amount becomes relatively large, it is possible to suppress a torque command value to be output from a controller so as to be lower than a torque limit value in accordance with a filter constant suitable for the shift amount. Accordingly, it is possible to realize high positioning accuracy irrespective of the level of the shift amount. According to the embodiments of the present invention, moreover, it is possible to appropriately suppress a torque command value without use of a filter constant which is fixed at a constant value suited for a case where a shift amount is relatively large. Accordingly, it is possible to realize high-speed processing irrespective of the level of the shift amount.

Hereinafter, detailed description will be given of the motor control device and the motor control system, by way of the respective preferred embodiments.

### 2. Motor Control System According to First Embodiment

### 2-1. Configuration of Motor Control System

With reference to FIG. 1, first, description will be given of the general configuration of the motor control system according to the first embodiment of the present invention. FIG. 1 is an explanatory diagram for explaining the configuration of the motor control system according to the first embodiment of the present invention.

As shown in FIG. 1, the motor control system according to this embodiment generally includes the motor control device 1, a command output device 2, a motor 3 (which may be a linear motor or a rotary motor), a position detector (e.g., an encoder) 4 that detects a position of the motor 3, and a load 5 that is an object to be driven by the motor 3. It is needless to say that the motor control system according to this embodiment does not necessarily include the load 5.

The motor control device 1 drives the motor 3, based on a position command output from the command output device 2 and a motor position detection signal indicating the position of the motor 3 detected by the position detector 4, such that the position of the motor 3 follows the position command. Thus, the motor control device 1 actuates the load 5.

The command output device 2 is one example of position command output devices. With regard to the position of the motor 3, the command output device 2 outputs, to the motor control device 1, a step-like position command as a target position (a position command) of the motor 3 or the load 5. Examples of data form to be output from the command output device 2 to the motor control device 1 include serial data, analog voltage, and the like.

The load 5 is an object to be driven and is coupled to an active member (e.g., a motor shaft) of the motor 3. In the load 5, a mechanism system typically has a vibration system as its characteristic, and this vibration system exerts an influence on performance in a positioning operation. The vibration system of the mechanism system in the load 5 may result in one of causes of generation of vibration in the positioning operation. The motor control system according to this embodiment also allows reduction of the vibration generated by the vibration system of the mechanism system in the positioning operation.

### 2-2. Configuration of Motor Control Device 1

With reference to FIG. 1, next, description will be given of the configuration of the motor control device 1 according to this embodiment.

As shown in FIG. 1, the motor control device 1 includes a shift amount calculator 6, a position command filter 7, a filter constant setting part 8, a controller 9 and a power converter 10.

Based on the position command output from the command output device 2, the shift amount calculator 6 calculates a shift amount per predetermined sampling time from the position command, and outputs the shift amount to the filter constant setting part 8. In this embodiment, because the position command is in the form of step, the shift amount calculator 6 can calculate the shift amount (which corresponds to an amount of shift to a target position based on the position command) immediately upon reception of the position command.

In this embodiment, based on the step-like position command output from the command output device 2, the shift amount calculator 6 outputs, to the position command filter 7, a position increment command indicating the shift amount per sampling time in the position command (which is also referred to as a position command increment value or segment data, corresponds to a speed conversion value of the position command, and is one example of the position command). This position increment command is in a form of impulse because the position command is in the form of step as described above. The shift amount calculator 6 can immediately calculate the shift amount as described above, and therefore can calculate the position increment command in a short time. For convenience of description about processing to be performed by the position command filter 7, in this embodiment, the shift amount calculator 6 calculates the impulse-like position increment command as one example of the position command. However, the shift amount calculator 6 does not necessarily calculate the impulse-like position increment command. The position command filter 7 may receive a step-like position command or a position command in a different form. In the case where the position command filter 7 receives the step-like position command, the shift amount calculator 6 may input the step-like position command from the command output device 2 as it is to the position command filter 7. In the case where the position command filter 7 receives the step-like position command, for example, a predetermined branch part may separate the step-like position command output from the command output device 2 into two, in a manner different from that shown in FIG. 1. Herein, one of the separated position commands may be input to the shift amount calculator 6 and the other position command may be input to the position command filter 7.

The position command filter 7 filters the position command (the position increment command which is one example of the position command in this embodiment) in accordance with a predetermined filter constant. Herein, the position command filter 7 filters the position command input thereto such that a time interval between acceleration and deceleration each performed by the motor 3 based on the position command output from the command output device 2 (i.e., a time interval from completion of acceleration to start of deceleration) becomes an integral multiple of a resonant period of the vibration system of the mechanism system in the load 5. More specifically, the position command filter 7 filters the position command such that a time interval during which the motor 3 is driven with almost constant speed based on the position command matches the integral multiple of the resonant period. In this embodiment, for the purpose of acquiring the impulse-like position increment command, which is one example of the position command, from the shift amount calculator 6, the position command filter 7 smoothes the impulse-like position increment command to obtain a pulse-like position increment command such that a constant speed segment becomes the integral multiple of the resonant period of the vibration system. By filtering the impulse-like position increment command as described above, the motor control system according to this embodiment can suppress excitation to be applied to the vibration system in the load 5 and reduce vibration in a positioning operation. Moreover, the motor control system can also prevent the torque command output from the controller 9 from being subjected to output limitation in the motor 3 or the amplifier (i.e., prevent the torque command from exceeding the output limit value). An example of the configuration of the position command filter 7 will be described later in detail.

The filter constant setting part 8 sets or changes the filter constant of the position command filter 7, based on the shift amount obtained by the shift amount calculator 6. The filter constant setting operation is performed prior to the filtering operation by the position command filter 7. The filter constant setting operation by the filter constant setting part 8 will be described in detail after the specific description about the configuration of the position command filter 7.

The controller 9 acquires the position command filtered by the position command filter 7 and a motor position signal indicating the current position of the motor 3 detected by the position detector 4. Based on the filtered position command and the current motor position, then, the controller 9 outputs a torque command for controlling the motor 3 such that the position of the motor 3 follows the filtered position command. In this embodiment, the position command filtered by the position command filter 7 serves as the position increment command which is one example thereof. Therefore, the controller 9 calculates, from the measured motor position, a change amount of the motor position per single sampling time (i.e., a value corresponding to a speed), and integrates a difference between the value and the position increment command. Further, the controller 9 outputs the torque command, based on a control gain of the controller 9, such that the integration value (a position deviation) decreases.

More specifically, the controller 9 includes a position control loop, a speed control loop and a current control loop (not shown), for example. The controller 9 acquires a result of detection from the position detector 4 and outputs, as a PWM (Pulse Width Modulation) signal, a voltage command based on the calculated torque command to the power converter 10. That is, the position control loop outputs a speed command for controlling the motor 3, based on the position increment command filtered by the position command filter 7 and the motor position detection signal detected by the position detector 4, such that the change amount of the motor position per sampling time follows the filtered position increment command. Moreover, the speed control loop outputs a torque command for controlling the motor 3, based on the speed command output from the position control loop, such that the speed of the motor 3 matches the speed command. Further, the current control loop outputs, as a PWM signal, a voltage command for controlling electric current in the motor 3 to the power converter 10 in accordance with the torque command output from the speed control loop.

In this embodiment, the controller 9 includes the three control loops; however, the present invention is not limited thereto. For example, the controller 9 does not necessarily include the speed control loop and/or the current control loop in so far as to include at least the position control loop.

The power converter 10 includes a gate drive circuit (not shown) and an inverter circuit (not shown), and applies, to a motor winding in the motor 3, a voltage according to the voltage command output as the PWM signal from the controller 9. As a result, the motor 3 is driven based on the voltage command, and the load 5 coupled to the motor 3 is actuated.

In the motor control system of related art shown in FIG. 8, when a torque command is a position command which can not be limited by a torque limit value, the vibration suppression filter can suppress vibration in a positioning operation to a certain extent. However, when a torque command is a step-like position command which may be limited by a torque limit value, there is a possibility that an overshoot occurs in the positioning operation.

In the motor control system according to this embodiment, on the other hand, the position command filter 7 reduces the vibration in the positioning operation, and the motor control device 1 includes the shift amount calculator 6, the filter constant setting part 8 and the like. Therefore, an appropriate filter constant can be set for the position command filter 7 in accordance with the shift amount even in the case of the step-like position command. Accordingly, the motor control system can avoid the torque command from being subjected to output limitation resulted from the torque limit value.

### 2-3. Configuration of Position Command Filter 7

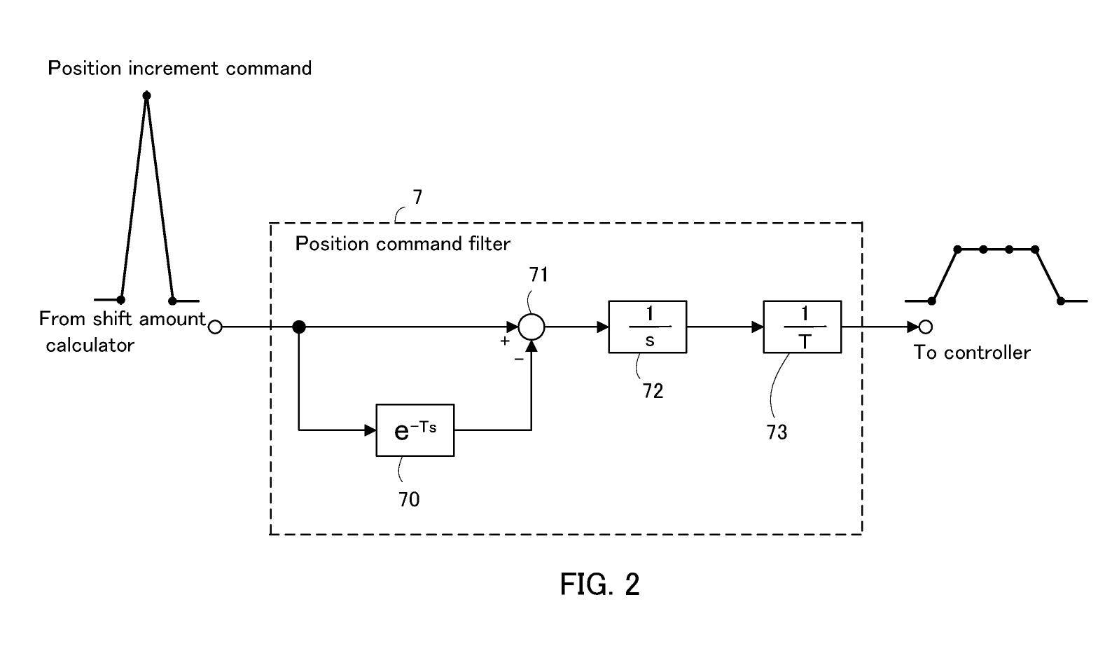

With reference to FIG. 2, next, description will be given of the specific configuration and the operations of the position command filter 7 in the case of receiving the position increment command as one example of the position command. As shown in FIG. 2, the position command filter 7 in this embodiment includes a delay unit 70, a subtraction unit 71, an integration unit 72 and a division unit 73.

The delay unit 70 delays the position increment command input thereto by the shift amount calculator 6, by a predetermined delay time T. The subtraction unit 71 subtracts the delayed position increment command by the predetermined time T in the delay unit 70 from the position increment command from the shift amount calculator 6. The integration unit 70 integrates the result of subtraction by the subtraction unit 71. The division unit 73 divides the integration value of the integration unit 70 by the delay time T in the delay unit 70. The position command filter 7 outputs, as the filtered position command, the division value of the division unit 73 to the controller 9.

Thus, the position command filter 7 can change the impulse-like position increment command into the pulse-like position increment command having the delay time T in the constant speed segment. Herein, the filter constant setting part 8 sets the value of the delay time T (i.e., one example of the filter constant) at a value expressed by Equation (1), based on a frequency f of the vibration system in the load 5. Thus, the position command filter 7 can convert the time interval between rising and falling of the impulse-like position increment command, that is, the time interval between acceleration and deceleration based on the position command (the time interval of constant speed drive) into the integral multiple of the resonant period (=1/f) of the vibration system. As a result, the excitation due to acceleration can be offset with the excitation due to deceleration. Therefore, the vibration in the positioning operation can be reduced.

$$T = \frac{n}{f} ( n = 1 , 2 , 3 , … ) \qquad ( 1 )$$

The position command filter 7 is not limited to the example shown in FIG. 2. Various filters are usable as the position command filter 7 as long as they can perform a filtering operation such that the time interval during which the constant speed drive is performed based on the position command becomes the integral multiple of the inverse (the resonant period) of the resonant frequency of the vibration system. As described above, for example, in the case where the position command to be input to the position command filter 7 is not an impulse-like position increment value, a filter to be used herein may have a configuration according to the input position command.

With regard to the step-like position command (i.e., the impulse-like position increment command), the position command filter 7 shown in FIG. 2 can accurately set the time interval during which the constant speed drive is performed based on the position command, at the integral multiple of the inverse (the resonant period) of the resonant frequency of the vibration system. In addition, the position command filter 7 filters the pulse-like position increment command, and therefore restricts the delay of output to a considerably low level (i.e., a delivery time of the position command (the pulse-like position increment command) is considerably short). In the case of using the position command filter 7 shown in FIG. 2, accordingly, it is possible to improve positioning accuracy with respect to a step-like position command and realize a quick positioning operation. As described in this embodiment, therefore, it is desirable to input the impulse-like position increment value to the position command filter 7 because the use of the position command filter 7 shown in FIG. 2 further exhibits the effects of this embodiment.

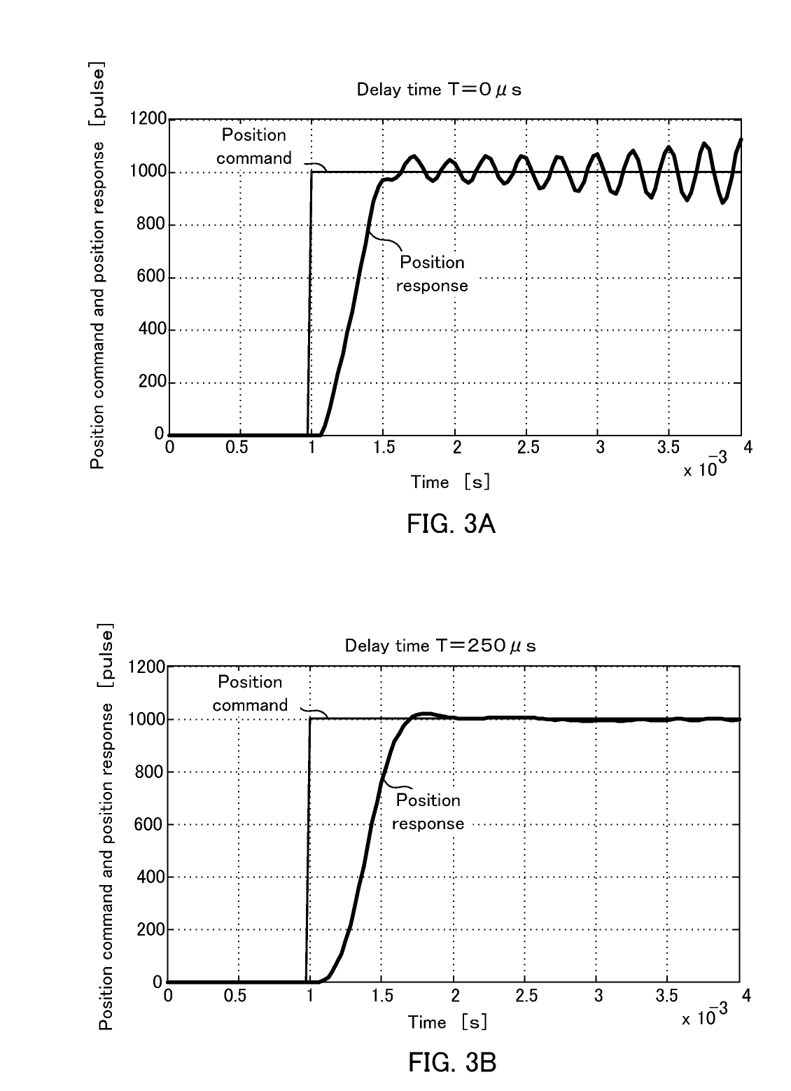

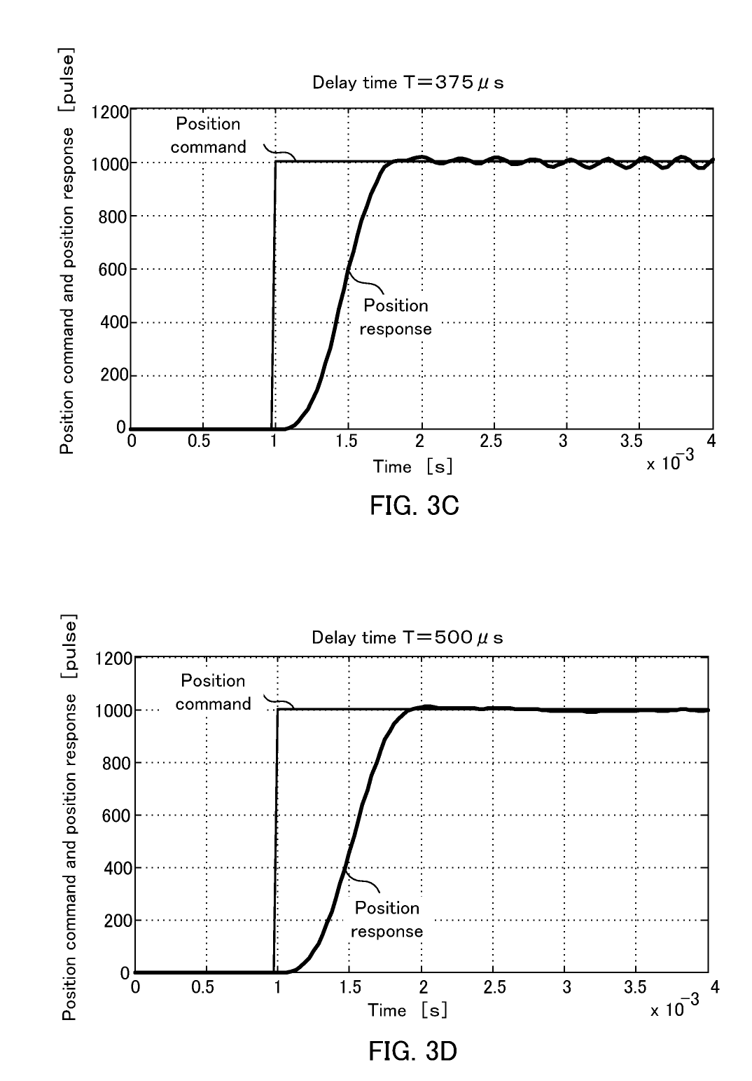

With reference to results of simulation shown in FIGS. 3A to 3D, next, description will be given of effects to be produced by the motor control system according to this embodiment in which the position command filter 7 shown in FIG. 2 is provided.

Each of FIGS. 3A to 3D is an explanatory diagram for explaining a result of simulation in the positioning operation in a case where the resonant frequency f of the vibration system in the load 5 is 4 kHz and the shift amount is 1000 pulses. FIG. 3A shows a waveform of a position command and that of a position response (e.g., a motor position detection signal) in a case where the delay time T in the position command filter 7 is zero. FIG. 3B shows a waveform of a position command and that of a position response in a case where the delay time T in the position command filter 7 is 250 μs (n=1). FIG. 3C shows a waveform of a position command and that of a position response in a case where the delay time T in the position command filter 7 is 375 μs. FIG. 3D shows a waveform of a position command and that of a signal response in a case where the delay time T in the position command filter 7 is 500 μs (n=2).

As shown in FIG. 3A, in the case where the delay time T is zero, a vibration of 4 kHz (a vibration waveform in a position response) occurs in the positioning operation and degrades the positioning accuracy. As shown in FIGS. 3B to 3D, however, in the motor control system according to this embodiment, the position command filter 7 and the like allow reduction of the resonant vibration generated by the vibration system of the mechanism system in the load 5 in the positioning operation.

It is understood from FIGS. 3B to 3D that the delay time T exhibits the vibration suppressing effect irrespective of a value thereof. The cases shown in FIGS. 3B and 3D that the delay time T satisfies Equation (1), i.e., the case that the position command filter 7 sets the time interval during which the constant speed drive is performed based on the position command at the integral multiple of the resonant period of the vibration system allows further improvement in vibration suppressing effect as compared with the case shown in FIG. 3C that the delay time T does not satisfy Equation (1).

### 2-4. Process in Filter Constant Setting Part 8

Next, description will be given of details of the process of changing the filter constant in the filter constant setting part 8.

As described above, the filter constant setting part 8 sets or changes the filter constant of the position command filter 7, based on the result of filtering by the position command filter 7, such that the time interval during which the motor 3 is driven with constant speed based on the position command becomes the integral multiple of the resonant period of the mechanism system in the load 5.

Herein, the filter constant setting part 8 changes the filter constant in accordance with the shift amount of the load 5 calculated by the shift amount calculator 6. More specifically, the filter constant setting part 8 gradually increases the time interval during which the motor 3 is driven with constant speed as the shift amount increases. On the other hand, the filter constant setting part 8 gradually decreases the time interval during which the motor 3 is driven with constant speed as the shift amount decreases. In other words, the filter constant setting part 8 changes the filter constant such that an integral value which is the integral multiple of the resonant period increases as the shift amount increases and decreases as the shift amount decreases.

The process in the filter constant setting part 8 is specifically described below by way of the position command filter 7 in this embodiment.

The torque value to be output from the controller 9 becomes large as the shift amount and the inertial moment of the load 5 are large, and also becomes large as the control gain of the controller 9 is high. The shift amount in the case where the torque command is subjected to output limitation so as not to exceed the output limit of the motor 3 or the amplifier can be readily obtained by experiment and the like with respect to the attached load 5 and the control gain set for the controller 9.

In the filter constant setting part 8, therefore, the resonant frequency f of the mechanism system in the load 5 and the minimum value of “n” at which the torque command is equal to or less than a limit value of the torque command with respect to the shift amount in the load 5 are set in advance. Based on the shift amount calculated by the shift amount calculator 6, then, the filter constant setting part 8 specifies the value of “n” correlated with the shift amount. Based on the resonant frequency f and the value of “n”, the filter constant setting part 8 calculates the delay time T from Equation (1). Thereafter, the filter constant setting part 8 sets the calculated delay time T as the filter constant of the position command filter 7. As described above, the value of “n” relative to the shift amount is set at the minimum value at which the torque command is equal to or less than the limit value of the torque command with respect to the shift amount. The use of the minimum value of “n” allows suppression of the possibility that the torque command is limited and reduction of the time required for shift to the target position.

It is desirable that the value of “n” relative to the shift amount is obtained by experiment and the like in advance and is recorded in the filter constant setting part 8 or a different recording device (not shown). Moreover, the delay time T is not calculated from Equation (1) by the filter constant setting part 8, but the delay time T relative to the shift amount may be obtained by experiment and the like in advance and then may be recorded in the filter constant setting part 8 or a different recording device (not shown). In this case, the filter constant setting part 8 obtains the delay time T, based on the relation between the recorded shift amount and the delay time T and the shift amount calculated by the shift amount calculator 6, and sets the delay time T for the position command filter 7.

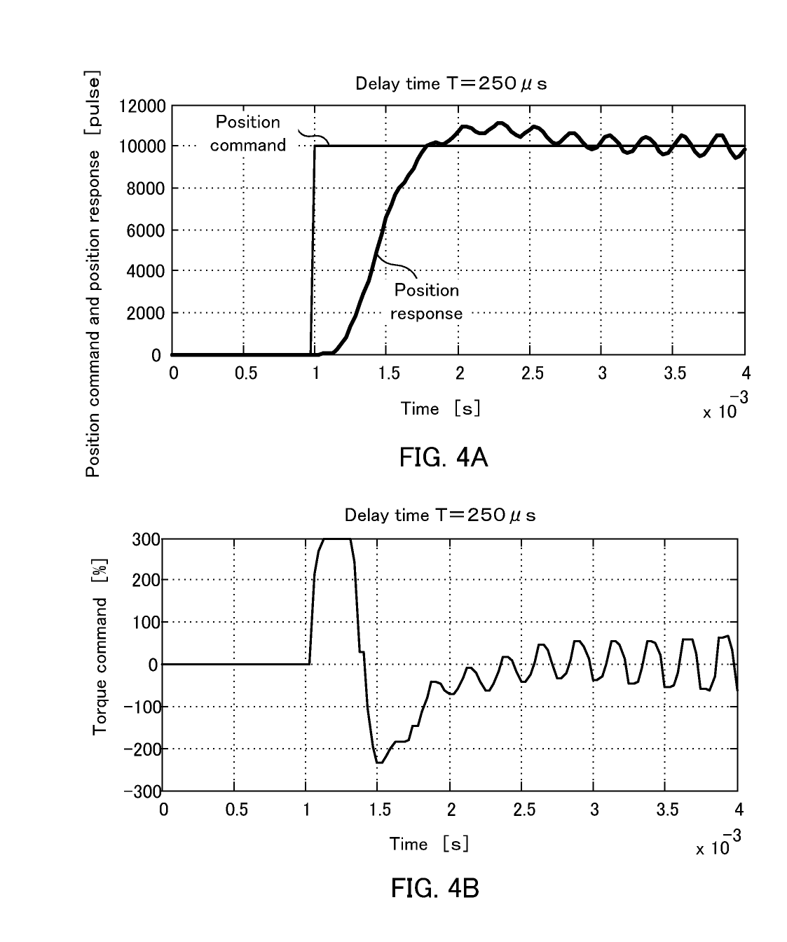

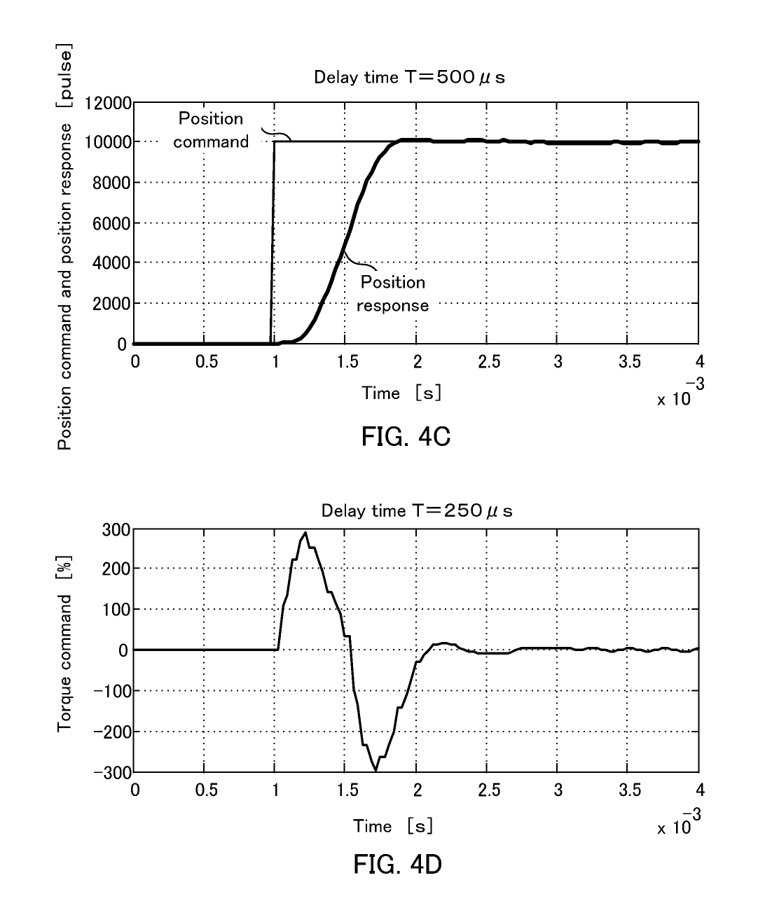

Each of FIGS. 4A to 4D is an explanatory diagram for explaining a result of simulation in the positioning operation in a case where the resonant frequency f of the vibration system in the load 5 is 4 kHz and the shift amount is 10000 pulses. FIG. 4A shows a waveform of a position command and that of a position response in a case where the delay time T in the position command filter 7 is 250 μs (n=1). FIG. 4B shows a waveform of a torque command (o) in the case where the delay time T is 250 μs (n=1). FIG. 4C shows a waveform of a position command and that of a position response in a case where the delay time T in the position command filter 7 is 500 μs (n=2). FIG. 4D shows a waveform of a torque command (o) in the case where the delay time T is 500 μs (n=2).

In the case of the shift amount of 10000 pulses, as shown in FIG. 4B, when the delay time T is 250 μs, the torque command exceeds 300%, so that torque limitation is imposed on the shift amount. In the same case, as shown in FIG. 4D, when the delay time T is 500 μs, the torque command does not exceed 300%, so that no torque limitation occurs.

In the examples shown in FIGS. 4A to 4D, accordingly, when the shift amount is 10000 pulses, the filter constant setting part 8 sets the delay time T at 500 μs in accordance with the shift amount.

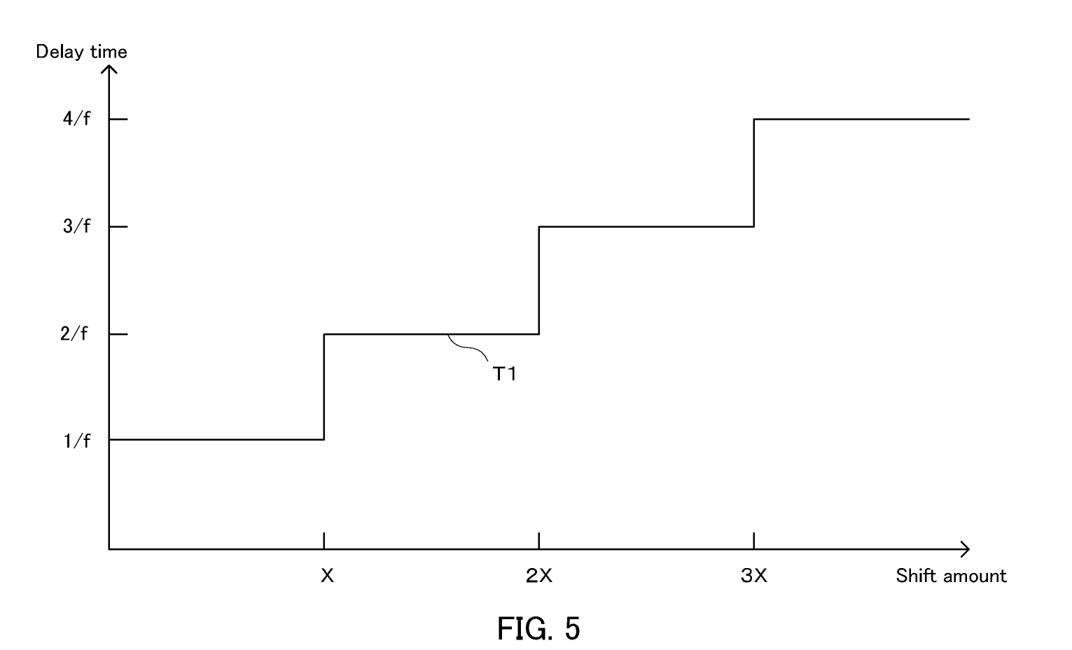

FIG. 5 shows an example of a value of the filter constant (the delay time) set for the position command filter 7 by the filter constant setting part 8 with respect to the shift amount. In FIG. 5, the shift amount X is a minimum shift amount to be subjected to the torque limitation in a case where the delay time is 1/f. As shown in FIG. 5, the filter constant setting part 8 sets a delay time T1 (an example of the delay time T) of the position command filter 7 at 1/f when the shift amount is less than X, 2/f when the shift amount is equal to or more than X but less than 2X, and 3/f when the shift amount is equal to or more than 2X but less than 3X.

That is, the filter constant setting part 8 according to this embodiment increases the delay time T1 as the shift amount increases. Herein, the filter constant setting part 8 discontinuously and gradually increases the delay time T1 such that the delay time T1 becomes an integral n multiple of the inverse of the resonant frequency f. As a result, in the case where the position command filter 7 filters the position command such that the time interval between acceleration and deceleration in the motor 3 based on the step-like position command becomes the integral multiple of the resonant frequency of the vibration system in the load 5, the filter constant setting part 8 gradually increases the time interval as the shift amount increases and gradually decreases the time interval as the shift amount decreases. As described above, it is possible to offset the excitation due to acceleration with the excitation due to deceleration irrespective of the level of the shift amount by the change of the filtering operation in the position command filter 7. As a result, it is possible to reduce the vibration in the positioning operation.

### 2-5. Examples of Effects in First Embodiment

As described above, the motor control system according to this embodiment can set the filter constant of the position command filter 7 at the minimum value for reducing the vibration generated by the vibration system of the mechanism system in the positioning operation, in accordance with the shift amount, without limitation of the torque command, in the case where the command output device 2 outputs the step-like position command. Accordingly, the motor control system can realize a quick and accurate positioning operation irrespective of a shift amount. Herein, the motor control system can also reduce vibration in a positioning operation. Therefore, the motor control system can be improved in stability and reliability, and allows reduction in noise.

### 3. Motor Control System According to Second Embodiment

The foregoing description is about the motor control system according to the first embodiment of the present invention.

In the motor control system according to the first embodiment, as described above, the filter constant is set in accordance with the shift amount. Therefore, the time interval during which the motor 3 is driven with constant speed increases as the shift amount increases. Thus, the motor control system can exhibit special functional effects of suppressing vibration, improving its stability and reliability, reducing noise, and realizing a quick positioning operation. Next, description will be given of the motor control system according to the second embodiment of the present invention. This motor control system can exhibit functional effects similar to those of the motor control system according to the first embodiment and, further, allows a more quick positioning operation.

### 3-1. Configuration of Motor Control System

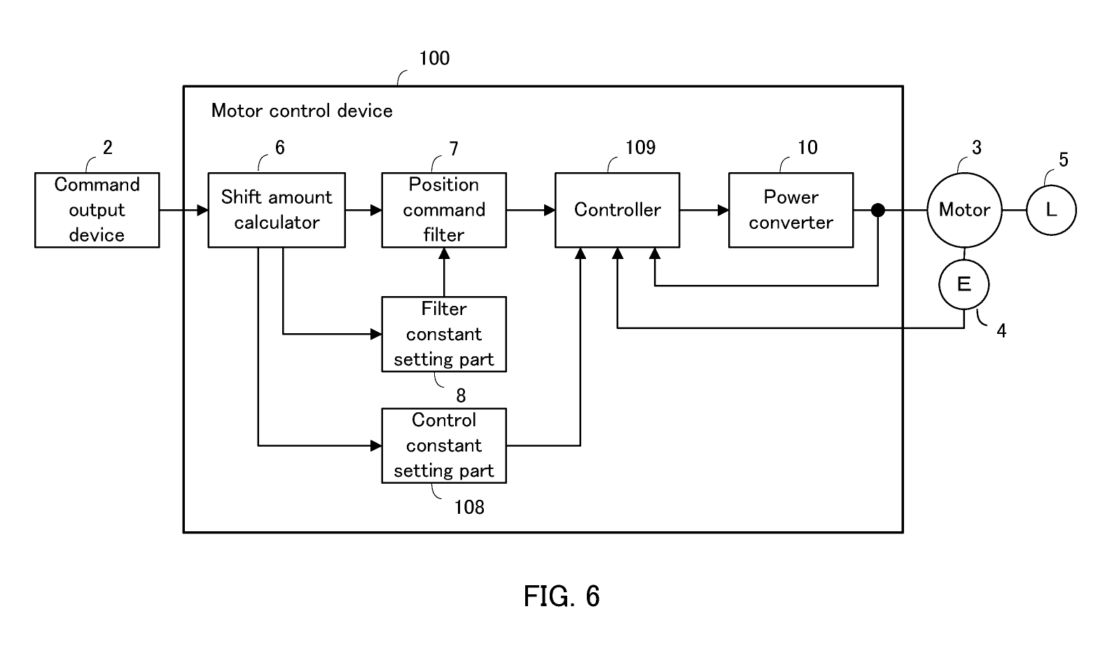

With reference to FIG. 6, first, description will be given of a configuration of the motor control system according to the second embodiment of the present invention. FIG. 6 is an explanatory diagram for explaining the configuration of the motor control system according to the second embodiment of the present invention.

As shown in FIG. 6, the motor control system according to this embodiment includes a motor control device 100 in place of the motor control device 1 in the motor control system according to the first embodiment. The motor control device 100 includes a controller 109 in place of the controller 9 in the motor control device 1 according to the first embodiment, and further includes a control constant setting part 108.

The remaining configuration in this embodiment is almost similar to that in the first embodiment as shown in FIG. 6. In the following, therefore, description will be mainly given of points of this embodiment different from those of the first embodiment. Herein, description about points of this embodiment identical with those of the first embodiment is omitted appropriately.

Basically, the controller 109 is configured as in the controller 9.

That is, the controller 109 acquires a position command filtered by a position command filter 7, and a motor position signal indicating a current position of a motor 3 detected by a position detector 4. Based on the filtered position command and the current motor position, then, the controller 109 outputs a torque command for controlling the motor 3 such that the position of the motor 3 follows the filtered position command. As in the controller 9, the controller 109 includes three control loops one of which is at least a position control loop. Herein, points of the controller 109 similar to those of the controller 9 are not described specifically.

Unlike the controller 9, the controller 109 is configured to allow the control constant setting part 108 to change a control constant in a control loop. This control constant is also referred to as a loop gain and serves as a factor of determining a response characteristic in each control loop. In this embodiment, the controller 109 includes the position control loop, the speed control loop located inside the position control loop, and the current control loop located inside the speed control loop, as one example of the control loop. Each of the control loops has the control constant which is also referred to as the loop gain for determining the response characteristic thereof. For example, the position control loop has the position loop gain. The response characteristic in the entire controller 109 is frequently determined by the position loop gain of the outermost control loop. In this embodiment, therefore, the controller 109 is configured to at least set or change the position loop gain as one example of the control loop.

Typically, it is desirable that with regard to the loop gain of each control loop, the inner one is higher (e.g., the loop gain of the inner control loop is about twice to four times as large as that of the outer control loop. If this balance becomes lost, the controller 109 becomes unstable, so that vibration generates in the positioning operation. Therefore, it is desirable that in the case of changing the response characteristic of the controller 109, the loop gain in the control loop other than the position control loop is adjusted such that the loop gain of the inner control loop becomes higher than (becomes equal to or more than about twice to four times as large as) that of the outer control loop. Herein, the gain adjustment for the inner control loop may be performed together with the gain adjustment for the position control loop by the control constant setting part 108 or may be performed by a different member such as the controller 109 in accordance with the position loop gain set by the control constant setting part 108.

The control constant setting part 108 sets or changes the control constant (the position loop gain in this embodiment) of the controller 109 in accordance with the shift amount output from the shift amount calculator 6. Herein, the control constant setting part 108 sets the control constant at a value at which the torque command output from the controller 109 is equal to or less than the limit value, the vibration in the positioning operation falls within a permissible range, and the positioning operation can be performed quickly. As a result, the control constant setting part 108 can synergistically produce the filter constant setting effect of the filter constant setting part 8.

Also in this embodiment, the filter constant setting part 8 sets the filter constant in accordance with the shift amount such that the filter constant (the delay time T) becomes the integral multiple (n times) of the resonant period (1/f) of the vibration system in the load 5, as in the first embodiment. In other words, a discontinuous value is gradually set at the filter constant. In this embodiment, however, the control constant setting part 108 sets the control constant (the position loop gain in this embodiment) so as to suppress the delay of the response due to the gradual setting of the filter constant.

In order to set the control constant in the control constant setting part 108, various methods are employed in accordance with the inertia, the vibration period and the like of the controller 109 and the load 5. In this embodiment, when the shift amount increases, the control constant setting part 108 temporarily changes at least the control constant before the filter constant setting part 8 increases the filter constant by one step. Herein, even in the case where the torque command exceeds the limit value, if the control constant is fixed, the control constant setting part 108 temporarily decreases the control constant to delay the response, and thereby suppresses the torque command to a value which is equal to or less than the limit value. As a result, the temporal change in the control constant allows the increase in the threshold value (X, 2X, 3X in FIG. 5) of the shift amount used when the filter constant setting part 8 increases the filter constant in order to prevent the torque command from being limited. This means that the filter constant setting part 8 does not need to increase the filter constant because the threshold value of the shift amount increases by the increase in the shift amount. Accordingly, it is possible to reduce the probability of increasing the filter constant and further enhance the positioning operation.

### 3-2. Process in Control Constant Setting Part 108

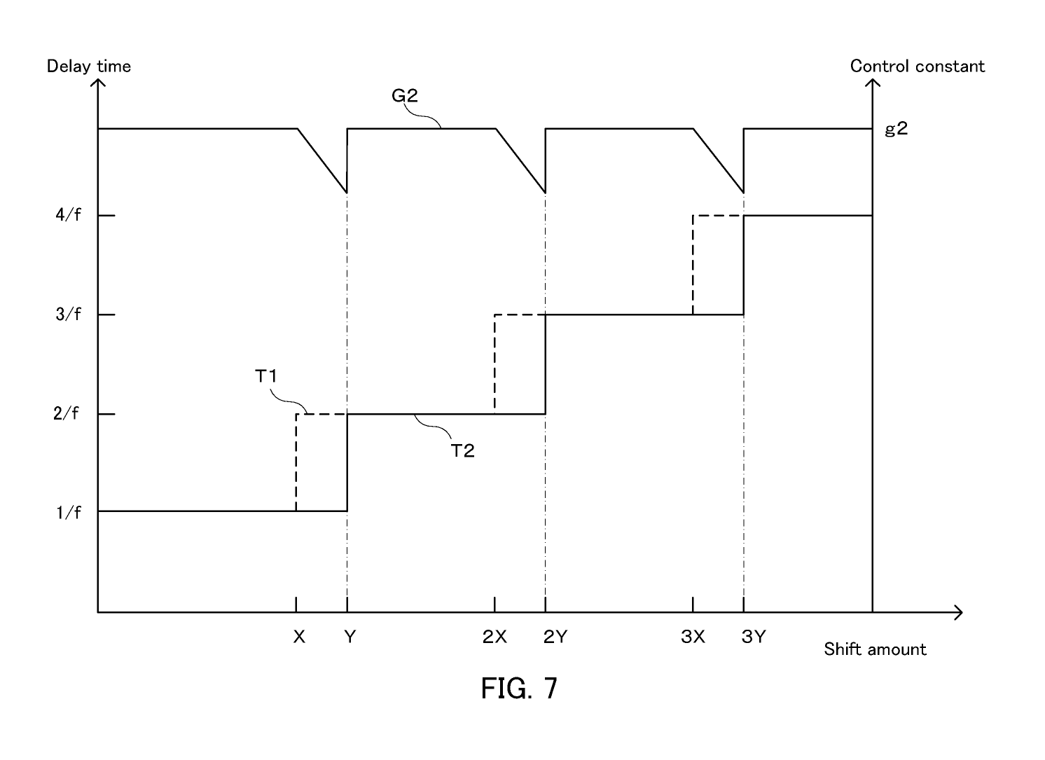

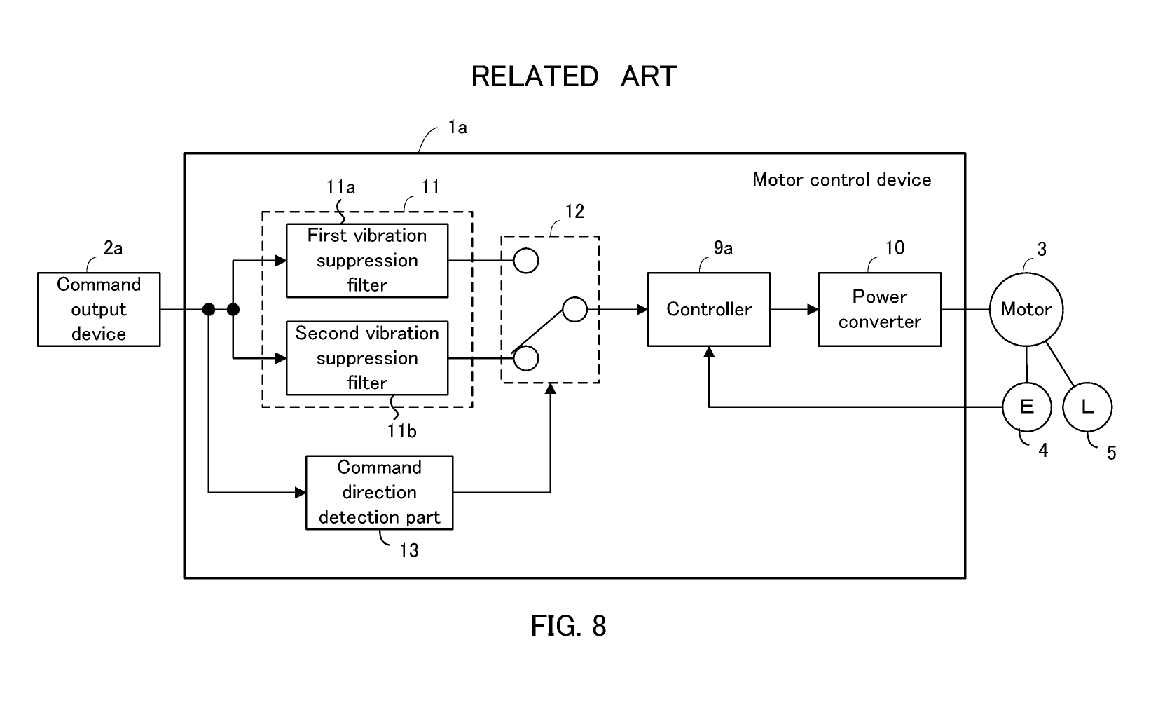

With reference to FIG. 7, more specific description will be given of the process of changing the control constant in the control constant setting part 108 in this embodiment. FIG. 7 is an explanatory diagram for explaining the relation between the shift amount and each of the filter constant and the control constant in the second embodiment of the present invention.

The shift amount Y shown in FIG. 7 denotes the minimum shift amount to be subjected to the torque limitation in the case where the delay time is 1/f in this embodiment. Moreover, the delay time T2 denotes the delay time to be set relative to the change in the shift amount in this embodiment. On the other hand, the shift amount X shown in FIG. 7 denotes the minimum shift amount to be subjected to the torque limitation in the case where the delay time is 1/f in the first embodiment. Moreover, the delay time T1 denotes the delay time to be set relative to the change in the shift amount in the first embodiment.

The position loop gain G2 shown in FIG. 7 denotes the control constant to be set by the control constant setting part 108 in accordance with the change in the shift amount in this embodiment. On the other hand, the position loop gain g2 shown in FIG. 7 denotes the control constant before subjected to adjustment by the control constant setting part 108.

As shown in FIG. 7, when the shift amount increases in this embodiment, the control constant setting part 108 temporarily decreases the control constant (the position loop gain g2) before the filter constant setting part 8 increases the filter constant (the delay time T2).

When the position loop gain G2 is reduced as described above, the response by the controller 109 is delayed temporarily, so that the torque command can be prevented from exceeding the limit value. Herein, the control constant of the controller 109 can be changed successively, unlike the filter constant to be increased gradually so as to suppress resonance. Accordingly, it is desirable that the control constant setting part 108 decreases the control constant (the position loop gain G2) by the minimum value within the range where the torque constant does not exceed the limit value. When the shift amount further increases, the control constant setting part 108 returns the control constant to its original value (the position loop gain g1) before the delay due to the decrease in the control constant becomes longer than the delay due to the increase in the filter constant by one step. Concurrently with or prior to and subsequent to this operation, the filter constant setting part 8 increases the filter constant by one step. Thus, the motor control system according to this embodiment allows finer adjustment in accordance with the shift amount and also allows suppression of the gradual response delay in the position command filter because of the gradual setting of the filter constant with respect to the shift amount in the first embodiment.

It is desirable that the control constant based on the shift amount is obtained in advance by experiment and the like in accordance with the load 5, as in the filter constant based on the shift amount, and is recorded in the control constant setting part 108 or a different recording device (not shown). Whether to change the filter constant of the position command filter 7 or change the control constant of the controller 109 may be selected based on which change achieves a good positioning characteristic in accordance with vibration and response speed in a positioning operation. Moreover, both the constants may be set while being adjusted appropriately. In addition to the configuration that the control constant and the filter constant each of which is based on the shift amount are stored in the filter constant setting part 8 and the control constant setting part 108, respectively, the motor control system according to this embodiment may employ a configuration that a separate constant controller (not shown) controls the filter constant setting part 8 and the control constant setting part 108 in accordance with the shift amount to determine which constant is adjusted.

### 3-3. Examples of Effects in Second Embodiment

In the second embodiment of the present invention, as described above, the motor control device 100 further includes the control constant setting part 108, and can change the control constant of the controller 109 in accordance with the shift amount. Accordingly, it is possible to adjust the response of the controller 109, i.e., the level of the torque command output from the controller 109, in accordance with the shift amount. In other words, it is possible to achieve fine adjustment in accordance with a shift amount such that the torque command is not limited in addition to the filter constant of the position command filter 7. In the second embodiment of the present invention, the motor control system can produce the effect of suppressing the gradual response delay of the position command filter because of the gradual setting of the filter constant with respect to the shift amount in the first embodiment, in addition to the effects produced in the first embodiment. Thus, the motor control system allows realization of a quick positioning operation. This effect is effective in a case where a period (1/f) of a vibration system is long or a case where a shift amount slightly exceeds a threshold value X so that a torque command is slightly limited. In this case, it is possible to achieve a quick positioning operation in a case where a control constant is set such that the response of the controller 109 is lowered slightly, as compared with a case where the filter constant of the position command filter 7 is increased by one step.

In the foregoing embodiments, the shift amount calculator 6 converts the position command output from the command output device 2 into the position increment command which is one example of the position command, and the position command filter 7 filters the position increment command. However, the present invention is not limited to this example. Alternatively, the shift amount calculator 6 may output the position command from the command output device 2 as it is to the position command filter 7. Still alternatively, the position command output from the command output device 2 may be input to the position command filter 7 without passing through the shift amount calculator 6. In this case, the position command filter 7 may filter the step-like position command such that the time interval during which the motor 3 is driven with constant speed based on the position command output from the command output device 2 becomes the integral multiple of the resonant period of the vibration system in the load 5.

In the forgoing embodiments, the configuration shown in FIG. 2 is described as one example of the position command filter 7, and the position command filter 7 is not limited to the configuration shown in FIG. 2 as long as it is a filter capable of filtering the time interval between acceleration and deceleration based on the position command such that the time interval becomes the integral multiple of the resonant period of the vibration system. In the position command filter 7 having the configuration shown in FIG. 2, the filter constant setting part 8 sets or changes the delay time T of the delay unit 70 of the position command filter 7, as one example of the filter constant. However, when the configuration of the position command filter 7 is changed, the filter constant to be changed by the filter constant setting part 8 is not limited to the delay time T. Therefore, it is needless to say that various constants may be employed as long as they allow the change in the integer.

In the second embodiment, the position loop gain is described as one example of the control constant to be set mainly by the control constant setting part 108. In the second embodiment, moreover, the controller 109 includes the three control loops, i.e., the position control loop, the speed control loop and the current control loop. However, the number and type of control loops are not particularly limited as long as the controller 109 includes at least the position control loop. The control constant to be set by the control constant setting part 108 may be the loop gain of any control loop. However, it is desirable that the control constant includes at least the position loop gain.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A motor control device comprising:
a position command filter configured to filter a position command in accordance with a predetermined filter constant, the position command being a step signal;
a controller configured to output a torque command to control a motor based on the position command filtered by the position command filter and based on a position of the motor detected by a position detection device such that the position of the motor follows the position command filtered by the position command filter;
a power converter configured to apply a voltage command based on the torque command to a motor winding in the motor;
a shift amount calculator configured to calculate a shift amount of the motor per sampling time based on the position command; and
a filter constant setting part configured to set the filter constant of the position command filter based on the shift amount calculated by the shift amount calculator.

2. The motor control device according to claim 1, wherein
the position command filter is configured to filter the position command such that a time interval during which the motor is driven with constant speed by the position command matches an integral multiple of a resonant period of a vibration system of a mechanism system in a load.

3. The motor control device according to claim 2, wherein
the filter constant setting part is configured to set the filter constant such that the time interval increases as the shift amount increases while the time interval decreases as the shift amount decreases.

4. The motor control device according to claim 3, further comprising:
a control constant setting part configured to set a control constant of the controller based on the shift amount calculated by the shift amount calculator.

5. The motor control device according to claim 4, wherein
when the shift amount increases, the control constant setting part at least temporarily decreases the control constant before the filter constant setting part sets the filter constant such that the time interval increases in accordance with the increase in the shift amount.

6. The motor control device according to claim 2, wherein
the shift amount calculator is configured to calculate, as a position command to be filtered by the position command filter, an impulse position increment command indicating the shift amount per sampling time based on the step position command, and is configured to input the position increment command to the position command filter, and
the position command filter is configured to filter the position increment command input to the position command filter from the shift amount calculator.

7. The motor control device according to claim 6, wherein:
the position command filter comprises
a delay unit configured to delay the position increment command by a predetermined delay time,
a subtraction unit configured to subtract the delayed position increment command from the non-delayed position increment command,
an integration unit configured to integrate a result of subtraction by the subtraction unit, and
a division unit configured to divide an integration value obtained by the integration unit by the delay time, and configured to output, as the position command filtered by the position command filter, a result of division to the controller; and
the filter constant setting part is configured to set, as the filter constant, the delay time at the integral multiple of the resonant period.

8. The motor control device according to claim 7, wherein
the filter constant setting part is configured to set the delay time at the integral multiple of the resonant period and at a minimum value at which the torque command output from the controller is equal to or less than a limit value of the torque command.

9. A motor control system comprising:
a motor configured to drive a load;
a command output device configured to output a position command indicating a position of the motor, the position command being a step signal;
a position detection device configured to detect the position of the motor; and
a motor control device configured to drive the motor based on the position command, the motor control device comprising:
a position command filter configured to filter the position command in accordance with a predetermined filter constant;
a controller configured to output a torque command to control the motor based on the position command filtered by the position command filter and the position of the motor detected by the position detection device such that the position of the motor follows the position command filtered by the position command filter;
a power converter configured to apply a voltage command based on the torque command to a motor winding in the motor;
a shift amount calculator configured to calculate a shift amount of the motor per sampling time based on the position command; and
a filter constant setting part configured to set the filter constant of the position command filter based on the shift amount calculated by the shift amount calculator.

10. The motor control system according to claim 9, wherein
the position command filter is configured to filter the position command such that a time interval during which the motor is driven with constant speed by the position command matches an integral multiple of a resonant period of a vibration system of a mechanism system in a load.

11. The motor control system according to claim 10, wherein
the filter constant setting part is configured to set the filter constant such that the time interval increases as the shift amount increases while the time interval decreases as the shift amount decreases.

12. The motor control system according to claim 11, wherein
the motor control device further comprises a control constant setting part configured to set a control constant of the controller based on the shift amount calculated by the shift amount calculator.

13. The motor control system according to claim 12, wherein
when the shift amount increases, the control constant setting part is configured to, before the filter constant setting part sets the filter constant, at least temporarily decrease the control constant such that the time interval increases in accordance with an increase in the shift amount.

14. The motor control system according to claim 10, wherein
the shift amount calculator is configured to calculate, as a position command to be filtered by the position command filter, an impulse position increment command indicating the shift amount per sampling time based on the step position command, and is configured to input the position increment command to the position command filter, and
the position command filter is configured to filter the position increment command input to the position command filter from the shift amount calculator.

15. The motor control system according to claim 14, wherein
the position command filter comprises
a delay unit configured to delay the position increment command by a predetermined delay time,
a subtraction unit configured to subtract the delayed position increment command from the non-delayed position increment command,
an integration unit configured to integrate a result of subtraction by the subtraction unit, and
a division unit configured to divide an integration value obtained by the integration unit by the delay time, and configured to output, as the position command filtered by the position command filter, a result of division to the controller; and
the filter constant setting part is configured to set, as the filter constant, the delay time at the integral multiple of the resonant period.

16. The motor control system according to claim 15, wherein
the filter constant setting part is configured to set the delay time at the integral multiple of the resonant period and at a minimum value at which a torque command output from the controller is equal to or less than a limit value of the torque command.
